(19) United States
(12) Patent Application Publication
(10) Pub. No.: US 2007/0114237 A1
(43) Pub. Date: May 24, 2007

(54) System and method to dispense single capsular bodies

(76) Inventor: Canegallo Pirottavio, Tortona (AL) (IT)

Correspondence Address: DICKSTEIN SHAPIRO LLP, 1825 EYE STREET NW, Washington, DC, 20006-5403, US

(21) Appl. No.: 11/284,888

(22) Filed: Nov. 23, 2005

(51) Int. Cl. G07F 11/66

(52) U.S. Cl. 221/25

(57) ABSTRACT

A system and method to dispense tables, confetti etc. entrapped in a complex film consisting of two layers with mechanical characteristics diversity, slidingly inserted in a container having at least: a cap or trap with door, a mechanism to tow the film in several steps, and a pass-no-pass device to force and break the trailed film to expel the confetti and recover the complex film more resistant layer.

The present invention concerns a system for dispensing, one by one, capsular products like tablets, pastilles, confectionery products, pills, solid medical products and the like, in small doses, said system comprising at least:—1) container means:—2) entrapping (encapsulating) means which carrier said products;—3) opening and closing means of said container means;—4) partial break means of said encapsulation and transport means;—5) means for the break of means 2) and for the outlet of said single encapsulated.

In a particularly simple, compact and effective embodiment, the system according to the invention has the structure of a cylindrical or parallelepiped case or box open at least on one side closable at least by a poly functional tap 3), in which box are introduced strips or necklaces (2) formed of at least two substantially thermoplastic films or sheets with characteristics diversity, welded to each other so to embed said products to singularly dispense, one of the necklace forming sheets being broken in its crossing a pass-no-pass device obtained from the cooperation of members associated to the poly functional tap (3) and of a wall projecting inside the container, which wall acts also as support of the necklace trailing device.

The invention concerns also a method to functionally embody said system, in which after:—having embedded said capsules, tablets, confectionary products and the like, between two films of characteristics diversity and having united them (with an adhesive and/or a seal);—having anchored a border or edge of said strip or necklace to a dragging device placed and supported on a not-central box portion so to allow the user's manual action; and—having associated the opening/closing door, it is possible to carry out at least: i) a trailing phase of the composite film; ii) a contact phase of the minor sector of the pastille container with two mini-zones of the pass-no-pass mechanism formed of elements associated, on one side, to the tap and, on the other side, to said box; and—iii) a phase of breaking the weaker film to expel and dispense to the user the involved capsule.

### DESCRIPTION OF THE RELATED ART

Pills dispensers and systems are known and commercialized, comprising, alone or in combination, elements selected from the group consisting of:—a box, a tap (with or without a small opening-closing door);—pills embedding and carrying means;—trailing means;—break means.

U.S. Pat. No. 4,163,496 describes a pills dispenser consisting of a top opened box and of a release closure element with two tongues aligned but remote to each other. U.S. Pat. No. 4,538,731 discloses a small flip-top container of small solid products, in particular of pastilles and the like, comprising a closure consisting of only one snap door. In the U.S. Pat. No. 4,733,797 the pills are sealingly enclosed in capsules or shells carried by a plastic segmented film or by a leaf like strip.

U.S. Pat. No. 6,155,454 concerns principally blisters.

European Patent Publication EP No. 1262422A2 (corresponding to the US Patent Publication No. 2002/0166869 A1) describes a sugar-coated pill dispenser including:—a container box body comprising a containing space and a U-formed space adapted to the form and size of the pills;—a complex tilting cap; and—a pair of coinciding cavities.

The variegated panorama of the “patent crowded field” of the dispensers can be completed by referring to the recent PCT-Publication No. WO 2004/009470A2 related to a distributor of medical products in different doses with the aid of a dispensing mechanism, comprising:—reception means of the medicament carrier;—means to release a dose;—on outlet;—dose indexing means; and—counting means.

The prior art dispensers associate to various advantageous characteristics a number of inconveniences whereby the market has punished or confined them to a few small niches.

### SUMMARY OF THE INVENTION

A first object of the present invention is to provide a system to dispense confectionary or pharmaceutical products which does not show the Prior Art drawbacks and, above all, is simple, effective, silent and easy to operate.

Another object of the invention is a method to manage and pilot said system in order to easily realize regular dispenses of single pill-form products by easily breaking the means which encapsulates and carries same tablets.

The system according to the invention is to dispense from a box or container (I CC), single (one by one) solid products with the shape of candies, chocolates, sugar—coated pills, pastilles, capsules, tablets and the like, entrapped in a supporting and transporting member comprises:—as carrier member;—a complex film of at least two layers having diversity of thickness, treatment and/or mechanical resistance (IV COL);—as box or container (I CC), a parallelepiped or cylindrical body having at least one open side in which are applied a tap (II T) with a small opening—closing door (A-C) and a trailing mechanism (III MT) to which shall be hooked the free edge or border (LE) of finished pieces of necklaces (COL) of said complex film embedding finite series of said solid products (CA, PM) to dispense.

The method according to the invention comprises the steps of:
preparing at least two films with diversity of thickness, brittleness and resistance to forces of tensile stress and break cut;
making holes and/or notches in the film showing minor thickness and resistance;
making possible ovular semi seats in the other film having major thickness and resistance;
adhering one film to the other preferably by welding;
making continuous necklaces of encapsulated products, said necklaces being obtained by welded overlapping of said two films;
inserting in succession said necklaces in a container body (I) comprising at least one opening/closing means (II) and a trailing (tow) means which preferably collects/recovers the more resistant and thicker film;
applying one inner free end or border of said necklace to said trailing means;
acting on said trailing means in several steps, particularly in three steps so to realize at least a first phase of trailing said necklace, a second phase to bring the encapsulated products in contact with at least two shoulders of a pass-no-pass device; and
a third phase to force said contact by further trailing up to the break of the weak film in order to obtain an opening adequate to the extraction of the product.

Further characteristics are recited in the claims which are at the end of this description but are considered herewith incorporated.

### BRIEF DESCRIPTION OF THE DRAWINGS

The various features and advantages of the present invention become better understood with regard to the following description, appended claims, and accompanying drawings where:

FIGS. 1, 3, 3A, 3B, 4, 4A, 5, 5A, 6 and 6A are schematic prospective views of an embodiment;

FIGS. 2, 2A, 5F, 5AF, 6F and 6AF are front views;

FIGS. 6P and 6AP are top views;

FIGS. 7, 7′ and 7″ are front views on an enlarged scale of the pass-no-pass mechanism in its three working phases; and

FIG. 8 is the block diagram of a process embodiment.

### DETAILED DESCRIPTION OF THE PREFERRED EMBODIMENT

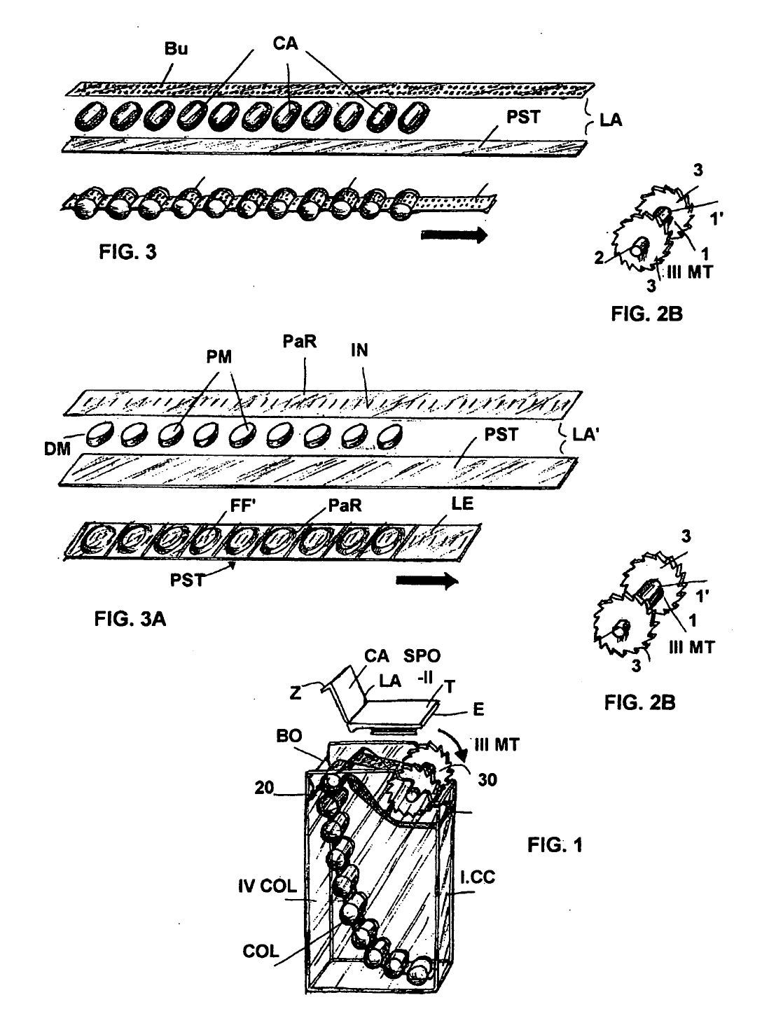

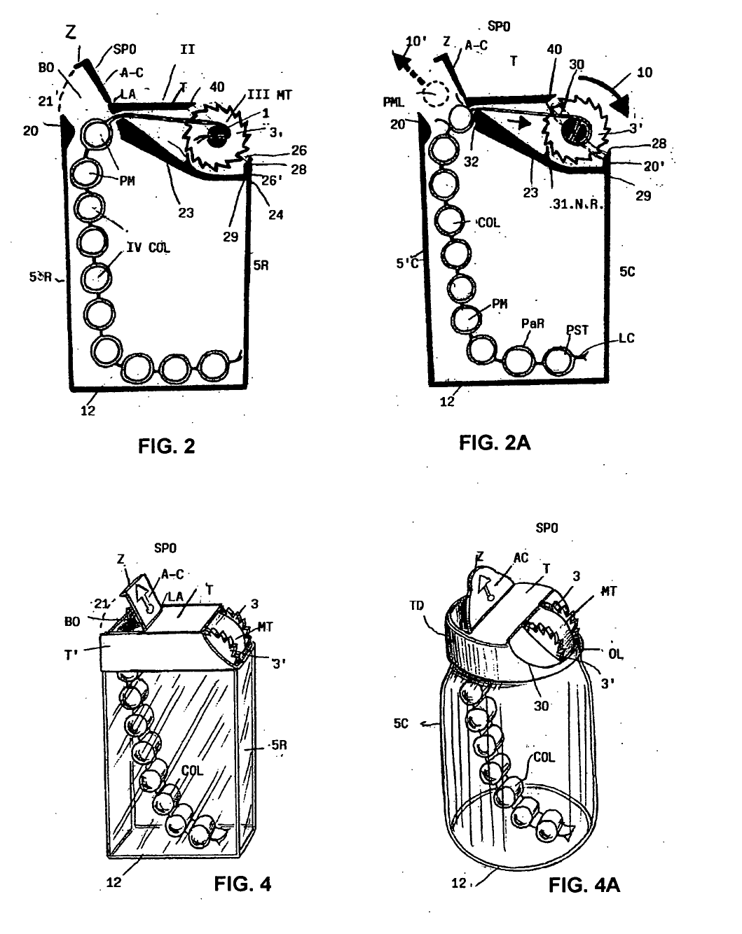

Referring to In the drawings, in particular in FIG. 1 and in the relevant front views of FIGS. 2 and 2A, the dispenser system according to the invention is schematically shown as essentially comprising: I)a container body CC;—II) a closing member or tap; III) a trailing (tow) mechanism MT; and—IV) a collector—carrier of the products to dispense, for instance tablets, sweet-meals etc. CA.

The container I. CC can have a polygonal (especially rectangular, square, trapezoidal etc.) cross section as in the FIGS. 1, 2, 2A, 4, 5, 5A, 5F, 5AF, 5P, 5AP, or round in particular with a circular, elliptical etc. cross section.

These container bodies or boxes I CC have a closed bottom 12 which is preferably integral with the side/polygonal walls e.g. 5R, 5′R or cylindrical wall 5C.

The top of the container body I CC (independently from its polygonal or cylindrical cross section) is open to be associated to a trai/tow mechanism II. MT having a substantially stationary closing portion or tap T, and to an opening—closing portion A-C with a small door SPO rotatable (over an angle of 90°) around an articulation line LA coincident with the inner end of tap T, the other outer end being free. The articulated portion of A-C terminates, at its distal end, with a bent spout Z which is shaped to be associated by form coupling to the upper end 20 of the wall 5′R when the articulated portion A-C is taken down and aligned with the stationary portion of tap T so to seal/close the mouth BO of the container or box I.

When said turnable portion A-C with opening-closing door SPO is rotated upwardly at right-hand (FIG. 1), it forms said mouth BO for the outlet of said candies CA (FIG. 2) or medical tablets PM (FIG. 3A); therefore the length of the door SPO of A-C from the articulation line LA up to the protuberance Z is such to correspond to a virtual radius of the hatched curve 21 (stroke of Z from the opening position to the closing position) slightly higher than the major dimension of the products to be dispensed.

Characteristically, the right-hand wall 5R of the polygonal box (FIG. 2) or wall 5C of the cylindrical box (FIG. 2A) is shorter than the left-hand wall 5R or 5′R and ends upwardly with a thickened portion 20′ at the lower end 29 of which engages the inner end of a third projecting wall 23, and at the upper portion 28 of which engages a fitting connector 30 between the corner 40 at the inner end of tap T and the chamfer 28 of the short wall 5R, 5C. This fitting connection has also the function to act as support of the rod 1 of the trailing mechanism MT at the end of which two sprocket wheels 3-3′ are engaged. As it can be seen from FIGS. 3 and 3A, said rod 1 projects slightly beyond the toothed wheels with protrusions 2-2′ (FIG. 3B) which slip in “ad hoc” seats (not shown) made preferably inside the two facing walls of the fitting connector 30. The rod 1 has preferably a slot 1′ within which slips the border LE at the inner end of the composite sheet FF, FF′ embedding the pastilles. FIG. 3 shows the case of sweetmeats or candies having a major dimension L, which, according to the invention, are encapsulated between two substantially thermoplastic PaR-PST sheets having mechanical characteristics diversity: the upper easily breakable sheet (PaR) can show a series of small holes BU and/or incisions IN; the lower sheet PST is more resistant (ticker and/or not weakened) than PaR and acts as trailer. Once the sweetmeats (confetto) CA are entrapped between the two sheets PaR and PST, said sheets are united (by welding or adhesive) and form a two-layer film FF which encloses said capsules and candies CA. In the case of the FIG. 3 the two sheets PaR and PST can have a width LA lower than the major dimension of confetto CA which will be covered at its ends: indeed sweetmeats, confetti, pastilles of confectionery etc. do not require a total coverage and thus a total protection.

FIG. 3A shows the case in which medical pills (tablets) PM, e.g., round with a diameter DM, are inserted between the two sheets PaR (with incisions IN) and PST (without weaknesses), both having a width LA′ slightly larger than the diameter DM, whereby the products PM will be entirely covered and protected at the moment of the two films welding with formation of a bi-layer film FF′.

The pitch, i.e., the distance between successive confetti CA or pills PM will substantially depend on their weight and size. The third wall 23 shows also a small tooth 23′ which by inserting itsself between two rocket teeth 3, 3′ acts as a no-return device.

In the case of non medical products such as sugarmeats, candies etc., optimal results have been obtained with a lower trailing film PST consisting of a laminate of polyester (PET)—aluminium (All)—polyethylene (PE) having thicknesses comprised in the hereunder ranges (in microns):
PET 19-23, Adhesive (AD)-All 7-25, Adhesive-PE 20-25.

In the absence of barrier, the All-sheet can be eliminated. As upper film PaR has been advantageously utilized a triple laminate:
PET 5-22, (AD)-All 7-(AD)-PE 20-25

Here too, if there is not need of a gas barrier, the metallic film can be eliminated or alternatively a mono-layer polyolefin film with a thickness of about 35μ preferably containing additives or treated with fancy-cut applied on the surface of only one film preferably that of the PE layer, or of both PE and PET films, can be used.

FIG. 4 is a perspective view of a dispenser with rectangular cross-section box I CC whereas in FIG. 4A the version with a cylindrical box 5C in shown, at a parity of trailing means MT and of opening-closing means T, A-C, SPO.

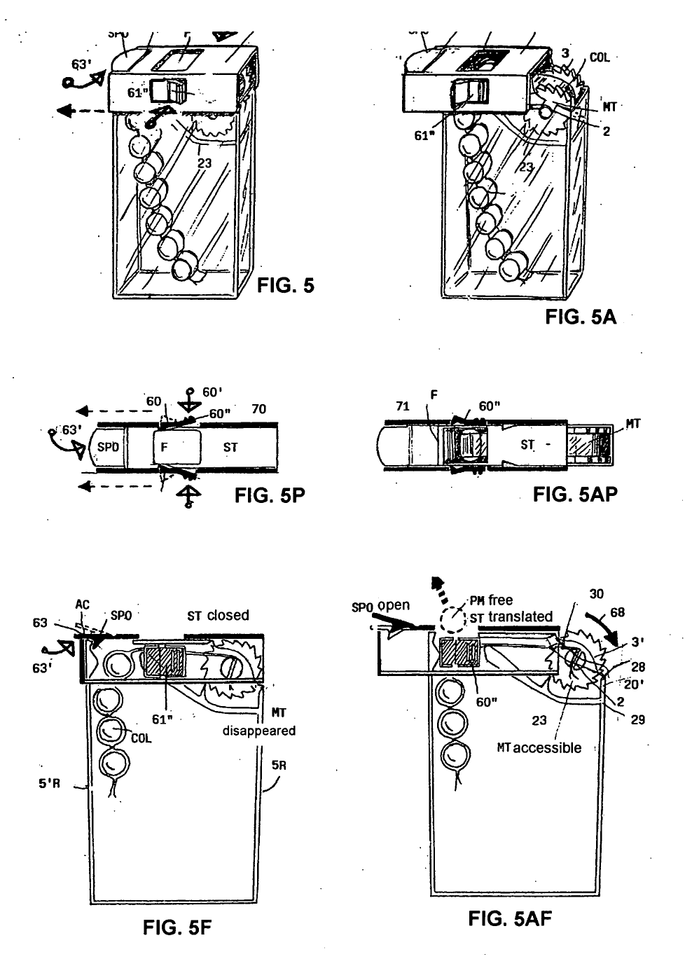

In FIGS. 5 and 5A (perspective views), 5F and 5AF (front view) and 5P, 5AP (top view) the version is shown of the dispenser of the FIGS. 1, 2 and 2A, additionally provided with a device to protect children, substantially consisting of an over-tap ST with opening-closing door A-C, SPO having now also a central window F.

Typically, the body ST-AC-SPO can be translated and pass from the initial position of FIGS. 5, 5P and 5F in which said body is stopped under the action of several teeth in particular those 60 and 61 associated to two lateral keys 60″ and 61″ and that 63 associated to the door A-C. To pass to the dispense or distribution, the two side keys 60″, 61″ are pressed in the direction of arrow 63′, and the tooth 63 is released by lifting door A-C in the direction of arrow 63′, whereby the whole over-top ST with window F can be translated from the compact position 70 of FIG. 5P to the cantilever position 71 of FIGS. 5A, 5F, 5AF where the small window F, which was blind before i.e. did not make visible the inner wall MT and, above all, blocked the outlet mouth of the medical pill PM, now thanks to the partial lifting of door A-C in the position 63″ where the mouth becomes free and contemporaneously the small toothed wheels R1 and R2 become accessible (in the position in 70 they were not accessible), the ergonometric action in the direction of arrow 68 becomes possible as in the old cigarette lighters i.e. with a very natural acting gesture.

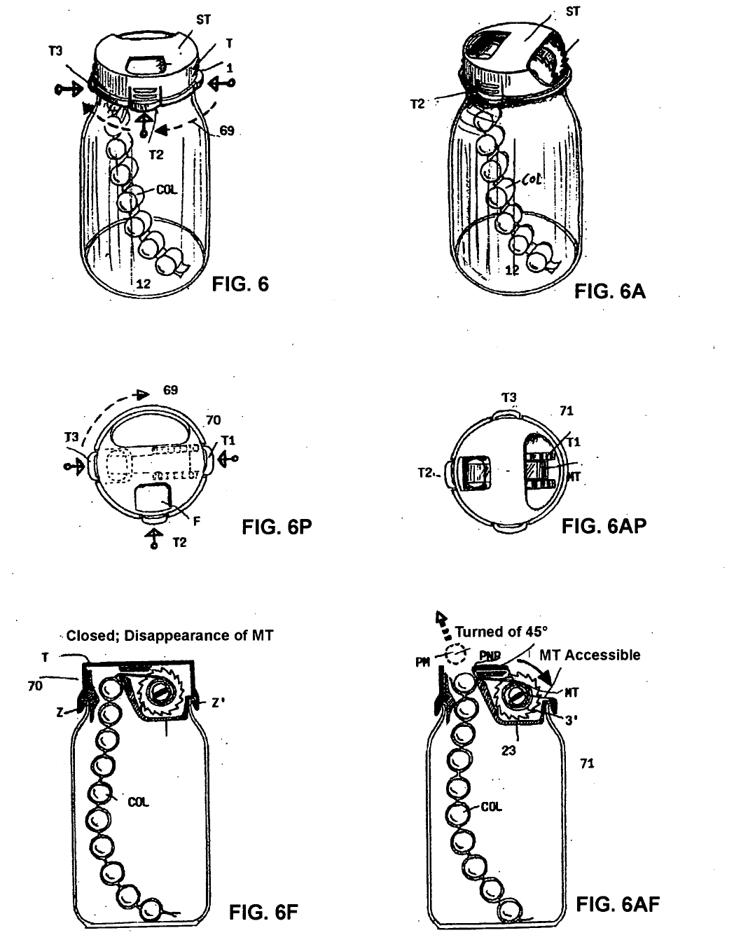

FIG. 6 shows the children protecting device associated to a cylindrical container: here the three keys T1, T2, T3 are pressed releasing the teeth thereto associated, the over-tap ST is turned in the direction of arrow 69 whereby the dispensing mouth is freed and the toothed wheels (priory hidden) become accessible. The working is substantially similar to that of the polygonal containers.

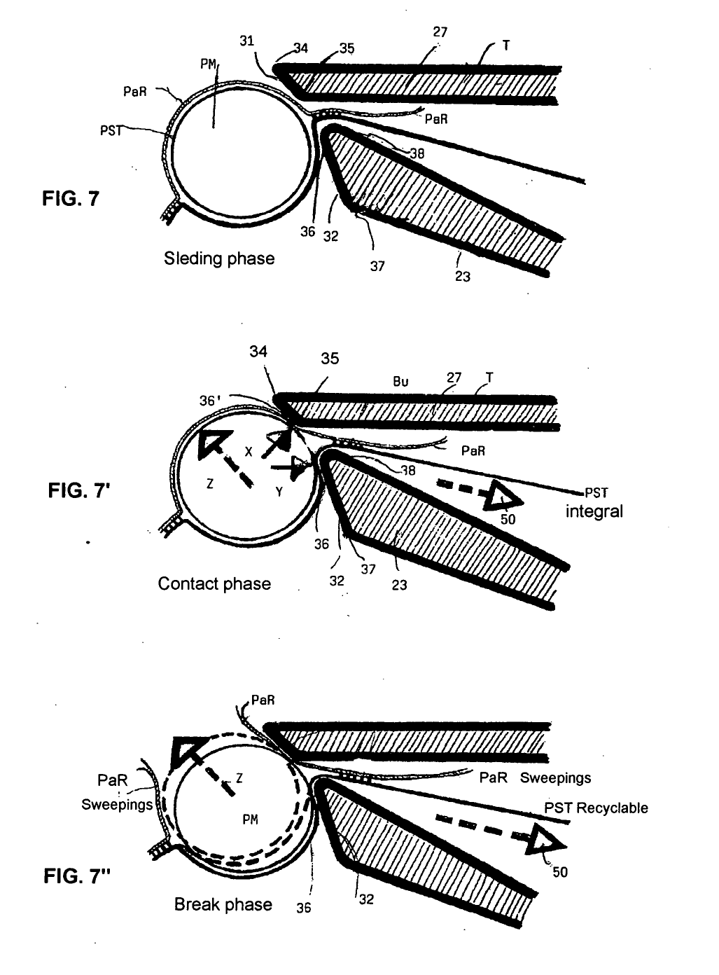

FIGS. 7, 7A, 7B (front views) show, on an enlarged scale, the steps of:
I) sliding of the composite sheet PaR+PST under the action of the trailing mechanism MT;
II) contact of the coated tables PM in at least two points 36-36′ of the tap element T with that of the third cantilevered wall 23 of box ICC;
III) break of the upper film PaR which under the tensioned contact effect in said points 36-36′ in the direction of arrows X-Y and the continuing trailing action of the trail mechanism MT, is submitted to a force in the direction of arrow Z which causes the break and the detaching of the weakened sheet PaR and the outlet of the tablet PM through the mouth BO.

Characteristically, the pass-no-pass device P-N-P is here formed by the sides (or inclined chamfers) 31 of T extending (from 34 to 35) and 32′ (from 27 to 38) of the projecting wall 23, which chamfers or bevels are mutually aligned or form an angle lower than 15° depending on the size, weight and consistency of the tablet PM (or CA). The contact points 36-36′ excert pressure in the directions of arrows X, Y against said chamfers 34-35 and 37-38 and generate a radial reaction force (indicated with the arrow Z) which causes the break of PaR, and the expulsion of tablet PM, without any damage to the thick trailing film PST that can therefore be recovered and recycled.

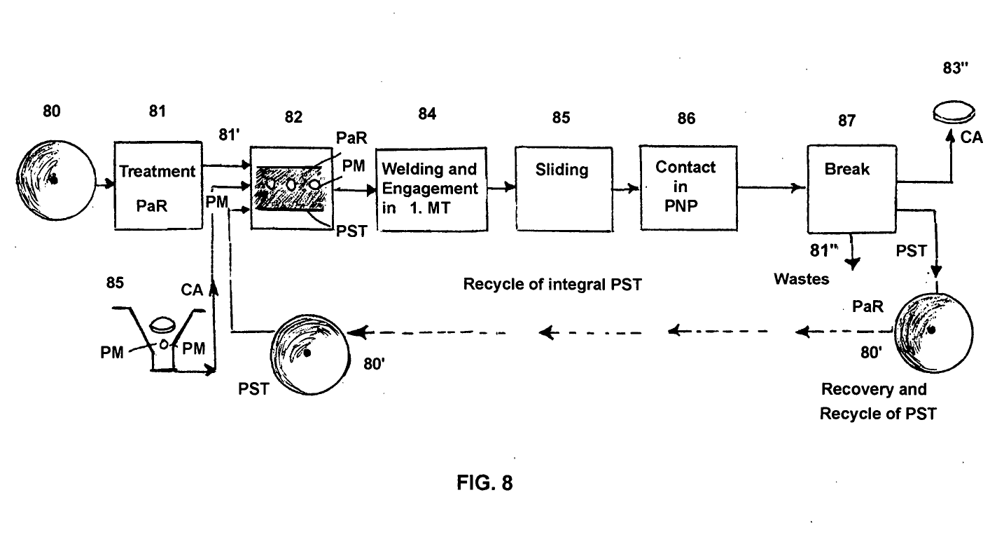

In the block diagram of FIG. 8, the reference 80 indicates a bobbin of basic film which is treated in 81 to get the break sheet PaR To the station of block 82 arrive the thick tow sheet PST from the bobbin 80′ and the candies CA or tablets PM from the hopper 85, which are carefully put down in PST and covered by the sheet PaR 81′ in outlet from the treatment 81. In 84 the package formed of PaR—tablets CA or PM, and PST is welded, the composite film FF (or FF′) is inserted in the container I.CC and in the pass-no-pass PNP and is engaged with its border LE to the slit of rod 1 of the tow mechanism M. This last mechanism carries out a first sliding tow in several steps preferably in three steps, i.e. in 85 a first sliding drag of FF (step I), a second tow in 86 to take in succession the tablets PM (or CA) embedded in FF into contact in at least two points with the pass-no-pass PNP (step II) and a third tow in 87 (step III) to force the tablets in a manner to exert a quasi radial stress on FF up to break the weaker film PaR.

At the outlet 87 are collected:—the now free tablets 83 or capsules CA or PM;—the wastes or residues 81″ of the now broken sheet PaR; and—the (not broken) thick tow sheet PST which is rewound on 80′ and recycled to the station 82.

The invention has been described, for illustration clarity scruple, with reference to the embodiments shown in the accompanying drawings; it is however susceptible of all the modifications which, being in the hand reach of the mean skilled person, fall naturally in the scope and spirit of the invention.

What is claimed is:

1. A system to individually dispense or deliver from a box or container (I.CC) provided with a cape or tap, one by one, solid products in form of sugar meats, chocolates, confetti, pastilles, pills, tablets and the like, entrapped in a carrying and transporting member, characterized in that it comprises:—as carrier member, a complex film of at least two layers having diversity of thickness, treatment and/or mechanical resistance (FF);—as box or container (ICC) a parallelepiped or cylindrical body having at least one open side in which are applied a tap (II T) with a small opening-closing door (A-C) and a trailing mechanism (III MT) to which shall be hooked the free edge or border (LE) of finished pieces of necklaces (COL) of said complex film embedding finite series of said solid products (CA, PM) to dispense.

2. A system according to claim 1, wherein said complexes film or sheet (FF) comprises:—a break sheet (PaR) mechanically treated and weakened by concentrated zones of reduced resistance to centrifugal forces and/or with reduced thicknesses; and—a tow (drag) thick sheet (PST9.

3. A system according to claim 2, wherein the break sheet (PaR) and the tow sheet (PST) are selected from the group of laminates comprising at least a layer of polyester (PET), a layer of Aluminium (All) and a layer of a polyolefin, in particular polyethylene or polypropylene, besides two intermediate mini-layers of adhesive.

4. A system according to claim 3, wherein the ranges of the film (PST) layer thicknesses are respectively from 19 to 23 microns for the PET, from 7 to 25μ for the All and from 20 to 25 μ for the polyolefin whereas in the break weakened film (PaR) the layer thickness ranges are 5 to 12μ for the (PET), 6 to 8μ for All and 15 to 25 for the polyolefin.

5. A system according to claim 4, wherein in the case of encapsulated products which do not require an appreciable gas barrier, the metallic layer is not present or alternatively the (PaR) laminate is substituted by a polyolefin single film with a thickness of about 35μ.

6. A system according to claim 1, wherein the cap or tap is inserted by form coupling substantially in the central portion of the box opening, the relevant small door snap-closes the left hand side of said opening and the tow mechanism is placed on the opposite portion of said opening and projects slightly from the tap free flank so to be ergonomically activated as an old cigarette lighter.

7. A system according to claim 1, comprising a child protecting mechanism consisting of hooking/releasing members on the box walls which are controlled by keys which, when contemporaneously pressed, release said members allowing an over-tap to expose the priory inaccessible tow mechanism, by parallelepiped translation or rotation in the case of cylindrical box.

8. A system according to claim 1, comprising a pass-no-pass mechanism which is formed by the ends of the tap lower wall and by the under lying below jetty wall of the box, which walls are chamfered so to have front sides forming angles lower than 60° over the box layer wall, that are however substantially in alignment and at a distance of a length corresponding to the diameter of a circular sector of the coated tablet, said sector being lower than 20% of the dispenser total circumference.

9. A method for extracting from containers, of protected and movable products of the pills-, tablet-, confectionary-, types, characterized by the steps of:
preparing at least two films with diversity of thickness, brittleness and resistance to forces of tensile stress and break cut;
making holes and/or notches in the film showing minor thickness and resistance;
making possible ovular semi seats in the other film having major thickness and resistance;
adhering one film to the other preferably by welding;
making continuous necklaces of encapsulated products said necklaces being obtained by welded overlapping of said two films;
inserting in succession said necklaces in a container body (I) comprising at least one opening/closing means (II) and a trailing means which preferably collects/recovers the more resistant and thicker film;
applying one inner free end or border of said neck lace to said trailing means;
acting on said trailing means in several steps, particularly in three steps so to realize at least a first phase of trailing said necklace, a second phase to bring the encapsulated products in contact with at least two shoulders of a pass-no-pass device; and
a third phase to force said contact by further trailing up to the break of the weak film in order to obtain an opening adequate to the extraction of the product.
